(19) United States
(12) Patent Application Publication
(10) Pub. No.: US 2026/0045058 A1
(43) Pub. Date: Feb. 12, 2026

(54) METHOD FOR ASCERTAINING A THREE-DIMENSIONAL BOUNDING VOLUME

(71) Applicant: dSPACE GmbH, Paderborn (DE)

(72) Inventors: Simon ROMANSKI, Karlsruhe (DE); Fabian BOTH, Karlsruhe (DE); Harald HANSELMANN, Karlsruhe (DE); Yassine MARRAKCHI, Karlsruhe (DE); Oscar DARWIN, Karlsruhe (DE); Michael WEBER, Karlsruhe (DE)

(73) Assignee: dSPACE GmbH, Paderborn (DE)

(21) Appl. No.: 19/266,756

(22) Filed: Jul. 11, 2025

(30) Foreign Application Priority Data
Aug. 7, 2024 (EP) 24193316.7

(51) Int. Cl. G06V 10/25; G06V 20/64

(52) U.S. Cl. CPC G06V 10/25; G06V 20/647

(57) ABSTRACT

A computer-implemented method for ascertaining a three-dimensional bounding volume, preferably a bounding box, for an object displayed on first data, the first data having at least three spatial dimensions, information data of a two-dimensional minimum bounding polygon being received for the object displayed on second data, a projection matrix, which defines a mapping of a three-dimensional data point of the first data onto a two-dimensional data point in the second data being received, and the three-dimensional bounding volume of the object being ascertained with the aid of a mathematical optimization procedure and a target function, the target function comprising fewer than 100,000 terms. The invention also relates to a device for processing data, which comprises computer components for carrying out the above method, as well as a computer program product, comprising commands, which, when the program is executed by a computer, prompt the latter to carry out the above method.

This nonprovisional application claims priority under 35 U.S.C. § 119 (a) to European Patent Application No. 24193316.7, which was filed on Aug. 7, 2024, and which is herein incorporated by reference.

### BACKGROUND OF THE INVENTION

### Field of the Invention

The invention relates to a computer-implemented method for ascertaining a three-dimensional bounding volume. The invention also relates to a device for processing data, to carry out the above method. The invention additionally relates to a computer program product, comprising commands, which, when the program is executed by a computer, prompt the latter to carry out the above method. The invention further relates to a computer-readable data carrier, on which the above computer program product is stored.

### Description of the Background Art

Autonomous and semi-autonomous driving has the potential to change mobility and, for example, to reduce travel times, energy consumption, and/or emissions. 3D object recognition has received a great deal of attention as an important component for autonomous driving, and approaches to 3D object recognition based on machine learning have gained in popularity in recent years.

Existing approaches to 3D object recognition may, in principle, be divided into two groups, depending on whether the output data are two-dimensional image data or three-dimensional point clouds, which are generally generated by lidar sensors. In methods based on image data captured by cameras, estimating the 3D bounding volume for an object made up of two-dimensional image data presents a major challenge. Due to rapid development in the field of machine learning and, in particular, in the area of deep learning technologies, image-based 3D recognition has nevertheless made remarkable progress.

A disadvantage of image-based 3D recognition using machine learning is, however, that a statistical algorithm such as an artificial neural network must be trained with a very large amount of learning data, which is complex. During the training, the learning algorithm learns a function which demonstrates the desired behavior, based on the characteristics of the learning data. The function learned in this manner is, however, a black box, since the relation of individual terms of the learned function to individual characteristics of the image data is unknown. In principle, the behavior is described in the form of an equation using the learned function, but without taking into account the complexity of the problem. Accordingly, black box models of this type are also not suitable for further knowledge gain.

In other words, it is therefore not clear to the user how dynamic and non-linearly programmed systems, such as artificial neural networks, deep learning systems, and/or genetic algorithms, obtain their results. This aspect of black box systems is problematic, in particular in the area of (semi-)autonomous vehicles, since the accountability is transferred more and more to the software and its results, due to the increasingly more intensive use of AI systems. In the field of tort law, for example, points of departure for the necessity of interpretability in using AI are being discussed.

Improvements in 3D object recognition are also necessary in connection with algorithms, such as neural networks, which must be trained with large data sets prior to their use as part of monitored learning. The data used for training are annotated during monitored learning, i.e., these are data in which the result of a classification to be learned by the algorithm is anticipated. In other words, the annotated data already have, for example, a bounding box around a 3D object, and/or they have a label indicating that the 3D object is a vehicle. The provision of annotated data of this type has up to now been associated with a great deal of, in part manual, effort, which is extremely time-consuming and cost-intensive.

### SUMMARY OF THE INVENTION

It is therefore an object of the invention to provide a 3D object recognition in an easy, fast, and/or cost-effective way.

According to an example of the invention, a computer-implemented method for ascertaining a three-dimensional bounding volume, preferably a bounding box, is provided for an object displayed on first data, the first data comprising at least three spatial dimensions, including the steps: receiving information data of a two-dimensional minimum bounding polygon, preferably a two-dimensional minimum bounding rectangle, for the object displayed on second data, the second data comprising at least two spatial dimensions, the received information data defining a size and a position of the minimum bounding polygon of the object in the second data; receiving a projection matrix, the projection matrix defining a mapping of a three-dimensional data point of the first data onto a two-dimensional data point in the second data; ascertaining the three-dimensional bounding volume of the object by means of a mathematic optimization procedure and a target function, the target function comprising fewer than 100,000 terms, comprising initiating information data of the three-dimensional bounding volume of the object, the information data defining a size, a position, and an orientation of the bounding volume of the object in the first data; generating information data of a further two-dimensional minimum bounding polygon by projecting the initiated bounding volume with the aid of the received projection matrix; and comparing the generated information data with the received information data.

In other words, the method according to the invention is a mathematical optimization procedure, by means of which the three-dimensional bounding volume, preferably the bounding box, is ascertained on the basis of the two-dimensional, minimum bounding polygon, preferably the rectangle. A mathematical optimization procedure is a minimization or maximization of the target function. The steps of initiating, generating, and comparing are preferably carried out multiple times until an abort criterion is reached. The target function in the present case include fewer than 100,000 terms, further preferably fewer than 10,000 terms, even further preferably fewer than 1,000 terms, and particularly preferably fewer than 100 terms.

In contrast to the method known in the conventional art using deep learning technologies, in which a target function having a very large quantity of terms—typically more than 100,000 terms—is learned during the training with the aid of learning data, in the present case, therefore, a target function is optimized, which comprises very few terms in comparison thereto. This has the advantage that the target function may be interpreted and explained and used for further knowledge gain. The target function in the present case is particularly preferably not learned from learning data, and the ascertainment of the three-dimensional bounding volume preferably does not take place by means of machine learning.

In other words, this is, for example, not a black box method but rather a white box method, in which the relation of the target function to individual parameters may be understood by the user.

Due to the method, a three-dimensional bounding volume, preferably a convex bounding volume, and particularly preferably a bounding box, is ascertained for the object displayed on the first data. The bounding volume is preferably an axis-aligned bounding box. The first data have at least three spatial dimensions, so that, in principle, the object may be visualized by plotting the first data in a three-dimensional grid. The particular values of a data point for the three spatial dimensions are also referred to as space coordinates (x, y, z).

In the first step of the method, the information data of the two-dimensional minimum bounding polygon and preferably of the two-dimensional minimum bounding rectangle are received. The two-dimensional minimum bounding rectangle is preferably an axis-aligned bounding box (AABB) of the object on the second data. The second data comprise at least the two spatial dimensions. As a result, the object displayed on the second data may preferably be visually represented by plotting the second data in a two-dimensional grid. The particular values of a data point for the two spatial dimensions are also referred to as image coordinates (x, y, z).

An AABB is a special minimum bounding polygon for the object displayed on the second data, the object preferably touching all four sides of the AABB. There is exactly one AABB for a compact—i.e., closed and bounded—2D object. This is the smallest possible axis-aligned rectangle that encloses the object. The AABB may be ascertained, for example, using a minimum and maximum search via coordinates of all corner points of the object in the second data.

The two-dimensional minimum bounding polygon and preferably the AABB are thus defined by their information data, which specify the size, particularly preferably the length of the two sides of the rectangle, and the position, particularly preferably the image coordinates of a point, for example a corner point or the middle of the rectangle, in the second data.

The first data and the second data preferably represent the same object. The first and second data preferably represent the same objects at essentially the same point in time. The first data and the second data are thus preferably temporally correlated with each other. In the present case, at essentially the same point in time or temporally correlated preferably means that a recording point in time of the second data—i.e., the data that has the at least two spatial dimensions—is situated between a start recording point in time and an end recording point in time of the first data, i.e., the data which have the at least three spatial dimensions.

The projection matrix can be received in a further step of the method. The projection matrix defines the mathematical mapping of a three-dimensional data point of the first data onto a two-dimensional data point in the second data. An image coordinate is therefore generated by applying the projection matrix to the spatial coordinates.

The three-dimensional bounding volume, particularly preferably the bounding box, can be ascertained, in that the mathematical optimization procedure is carried out with the target function.

The information data of the three-dimensional bounding volume may be first initiated as the starting point. They comprise the size, the position, and the orientation of the bounding volume in the first data. The three-dimensional bounding volume, preferably the bounding box, is thus defined by its information data, which specify the size, particularly preferably the length of the three sides of the bounding box, the position, particularly preferably the spatial coordinates of a point, for example a corner point or the middle of the bounding box, and the orientation, particularly preferably three angles, for example the roll/pitch/yaw angles.

Information data of a further two-dimensional minimum bounding polygon, and preferably the AABB, can be generated by projecting the initiated bounding volume with the aid of the received projection matrix. In other words, the initiated bounding volume is thus preferably projected into the two-dimensional image coordinates with the aid of the projection matrix.

Afterwards, a consistency check can be carried out, in that the generated information data are compared with the received information data. The result of the projection is thus preferably compared with the originally received AABB. The steps of initiating, generating, and comparing are preferably carried out multiple times until an abort criterion is reached, in particular with respect to the consistency check.

The first data can be a point cloud recorded with the aid of a lidar or radar sensor. The first data are therefore preferably sparse data, since the lidar or radar sensor records a value only at a few discrete spatial coordinates.

The second data can be image data recorded with the aid of a camera. It is particularly preferably provided that the projection matrix is defined by the orientation and the position of the sensor used for recording the first data in relation to the camera.

It is possible that the received information data of the two-dimensional minimum bounding polygon can be generated by manual annotation of the image data recorded with the aid of the camera. However, it is preferably provided that the image data recorded by the camera are evaluated with the aid of machine learning, and the two-dimensional minimum/bounding polygon and preferably the AABB are ascertained in this way. The received information data particularly preferably comprise not only the size and position of the two-dimensional minimum bounding polygon, but additionally an essentially vertically oriented line, which identifies the essentially vertically running edge of the object displayed on the second data which is closest to the recording camera. In particular when solving the mathematical optimization procedure, this line makes it possible to define a sensible initial value for the orientation of the bounding volume in the first data during the initiation of the information data of the three-dimensional bounding volume of the object. Within the scope of this invention, essentially vertical preferably comprises vertical lines±45 degrees.

The method also comprises the step of receiving the first data, the received data being taken into account when ascertaining the three-dimensional bounding volume of the object by means of the mathematical optimization procedure. Particularly good results may be achieved during the ascertainment of the three-dimensional bounding volume if the first data are taken into account in the optimization. This may be implemented, for example, in that three-dimensional bounding volumes are preferred during the optimization which comprise a particularly large amount of three-dimensional data points of the first data, or in that a quantity of three-dimensional data points outside the bounding volume are minimized.

In connection with the mathematical optimization procedure, it is possible, in principle, to jointly optimize all nine existing variables of the three-dimensional bounding volume of the object—preferably three spatial coordinates for the position, three lengths for the size, and three angles for the orientation—with the aid of a target function. According to one preferred refinement of the invention, it is, however, provided that the mathematical optimization procedure comprises an optimization of three target functions, each having fewer than 100,000 terms, only the position of the three-dimensional bounding volume being optimized with the aid of the first target function, only the size of the three-dimensional bounding volume being optimized with the aid of the second target function, and only the orientation of the three-dimensional bounding volume being optimized with the aid of the third target function. It has become clear that the separate optimization of the position, the size, and the orientation has the advantage that the target functions are less complex, and the terms of the target functions have a relation to empirical observations. Each of the three target functions preferably have fewer than 10,000 terms, further preferably fewer than 1,000 terms, and particularly preferably fewer than 100 terms. The optimizations are staggered with respect to each other by this procedure.

The mathematical optimization procedure can comprise an iterative optimization, preferably minimization, of the three target functions and is begun with the first target function. It has been shown that the optimization delivers particularly good and particularly fast results if it begins by optimizing the position of the three-dimensional bounding volume and is followed by the other two optimizations-size and orientation. The orientation is preferably optimized after the optimization of the size. In addition, it is further preferred if the optimization of the position is begun again after the first optimization of the size and the orientation.

In relation to the optimization of the position with the aid of the target function, it can be provided that two of the three spatial coordinates are converted into a depth parameter based on their linear dependency. In the case of a clockwise spatial coordinate system, in which the z axis is defined by the depth detection of the lidar or radar sensor and the y axis by the vertical direction, the space coordinates x and z may be converted into the depth parameters. This is possible since, for an existing visual axis of the sensor, which is used to record the first data, the space coordinates are linearly dependent on each other due to the conversion into the image coordinates.

It is also provided in relation to the first target function that a first target function can comprise at least one term and can be a linear combination of at least three terms. It is also possible to ascertain a very suitable three-dimensional bounding volume with only three terms.

In relation to the first term, it is preferably provided in this connection that the first term can be a 2D/3D consistency term, which is ascertained by comparing the generated information data with the received information data. The first term particularly preferably comprises the Jaccard coefficient, also referred to as Intersection over Union, to ascertain the similarity of the back-projected two-dimensional minimum bounding polygon with the originally received two-dimensional minimum bounding polygon. In this regard, it is particularly advantageous if the middle of the back-projected, two-dimensional minimum bounding polygon is placed on the middle of the originally received, two-dimensional minimum bounding polygon for the purpose of ascertaining the 2D/3D consistency term, since smaller projection errors of this type do not have any influence. It is also advantageous if the 2D/3D consistency term comprises a tolerance term, so that the 2D/3D consistency term has its minimum value (or alternatively its maximum value) even in the case of non-ideally matching polygons.

The second term can be a 3D point population term, which is ascertain by an ascertainment of a quantity of three-dimensional data points of the first data within the initiated and/or ascertained three-dimensional bounding volume of the object.

Further, the method can comprise the step of receiving the first data. In other words, the quantity of three-dimensional data points present within the three-dimensional bounding volume is ascertained. When ascertaining the quantity of three-dimensional data points within the bounding volume, the bounding volume is preferably not defined as a bounding box during the optimization of the position of the three-dimensional bounding volume—preferably the depth parameter—but rather as a cylinder whose rotation axis is in parallel to the y axis, or as a sphere. This has the advantage that errors relating to the orientation of the initiated and/or ascertained bounding volume due to the rotational symmetry do not have an influence. It is further preferably provided that the expansion of the cylinder along the rotation axis is not incorporated into the ascertainment of the quantity of three-dimensional data points, since the robustness of the second term toward errors relating to the ascertainment of the ground plane may be increased thereby.

It may also be further preferably provided that the point population term can be normalized, in that a quantity of three-dimensional data points of the first data is ascertained, which, after the projection with the aid of the projection matrix, are situated within the two dimensional minimum bounding polygon defined by the received information data. The point population term may furthermore be normalized in that a quantity of three-dimensional data points of the first data is ascertained, which are situated within a truncated pyramid or frustum, which has the same opening angle as the two dimensional minimum bounding polygon defined by the received information data.

The third term can be a bounding volume distance term, which is ascertained by ascertaining a distance of a surface of the bounding volume to a side and preferably a side of the object facing the lidar or radar sensor. In relation to the first data, objects are scanned by the sensor only on surfaces oriented in the direction of the sensor, due to their self-occlusion. Accordingly, it is advantageous to use local pieces of information—in the present case, preferably a local point density of the first data—to identify the surface of the object in the first data facing the sensor and to use it to move the three-dimensional bounding volume as close as possible to these three-dimensional data points belonging to the surface. The bounding volume distance term preferably favors positions of the three-dimensional bounding volume during the optimization, at which the distance of the three-dimensional bounding volume to the surface of the object facing the sensor is as short as possible.

It can also be provided that the 2D/3D consistency term of the first target function can comprise a distance term, which preferably favors positions of the three-dimensional bounding volume which have great distances to the lidar or radar sensor. The distance term preferably behaves linearly with respect to the distance to the lidar or radar sensor and cancels out the symmetry of the consistence calculation with the aid of the Jaccard coefficient. In the case of first data in which the local point density is particularly low, multiple positions of the three-dimensional bounding volume may have similarly high values in a target function comprising the three terms described above, and correspondingly no one position may be preferred during the optimization. This may preferably be avoided in that the 2D/3D consistency term also includes the distance term, and positions of the three-dimensional bounding volume having great distances to the lidar or radar sensor may be preferred during the optimization in this way and move the three-dimensional bounding volume closer to the surface of the object facing the sensor.

The first target function particularly can comprise the 2D/3D consistency term, the 3D point population term, and the bounding volume distance term. According to one preferred refinement of the invention, it is also provided that the first term has a higher weighting and preferably a double weighting±20% than the second term, and the second term has a higher weighting and preferably a weighting that is at least 50 times that of the third term. It has become clear that these weightings permit a particularly good ascertainment of the three-dimensional bounding volume by means of the mathematical optimization procedure.

As mentioned above, only the size of the three-dimensional bounding volume may be optimized with the aid of the second target function. In this regard, it is provided according to a further preferred refinement of the invention that the second target function comprises at least one term and is preferably a linear combination of at least two terms.

The first term can be a 2D/3D consistency term, which is ascertained by comparing the generated information data with the received information data. Similarly to the first target function, the second target function preferably also comprises the 2D/3D consistency term.

The second term of the second target function can be a prior knowledge term, and the method can comprise the step of receiving a classification result of the object. In relation to the size of the three-dimensional bounding volume, predefined size distributions dependent on the class of the object are thus preferably used, and Gaussian distributions of the size are particularly preferably used. For example, a first predefined size distribution is used for compact cars, and/or a second predefined size distribution is used for trucks. In principle, the size of objects, in particular vehicles, may be described by Gaussian mixture models. A mixture model is a model for representing the presence of sub-populations within a total population. The prior knowledge term preferably favors sizes of the object near the mean and/or median value of the corresponding sub-populations during the optimization, taking into account the classification result. This may be mathematically formulated, for example, via conditional probability distributions.

The second target function can comprise the first and second terms. In this regard, it is provided according to one preferred refinement of the invention that the first term and the second term have the same weighting±20%. This results in particularly good results when ascertaining the three-dimensional bounding volume.

The second term may also comprise a 3D point population term, which is ascertained by an ascertainment of a quantity of three-dimensional data points of the first data within the initiated and/or ascertained three-dimensional bounding volume of the object. In this regard, it is particularly preferably provided that, in contrast to the position optimization, the extension of the bounding volume along the z axis is also examined in the size optimization. In this connection, it is furthermore preferably provided that the method comprises the step of receiving the first data.

Similarly to the first target function, the second target function may also comprise a bounding volume distance term, which favors sizes of the three-dimensional bounding volume during the optimization, in which the distance of the three-dimensional bounding volume to the surface of the object facing the sensor is as short as possible.

As mentioned above, only the orientation of the three-dimensional bounding volume may be optimized with the aid of the third target function. In this regard, it is provided according to a further preferred refinement of the invention that the third target function comprises at least one term and is preferably a linear combination of at least two terms.

The first term can be a 2D/3D consistency term, which is ascertained by comparing the generated information data with the received information data. Similarly to the first and second target functions, the third target function also preferably comprises a 2D/3D consistency term. In this connection, it is preferably provided that the 2D/3D consistency term relating to the orientation takes an aspect ratio of the back-projected, two-dimensional minimum bounding polygon as well as an aspect ratio of the two-dimensional minimum bounding polygon originally received into account during the comparison. In particular, the yaw angle, a rotation around the y axis (vertical axis) influences the aspect ratio of the back-projected AABB.

The second term can be a 3D point population term, which is ascertained by an ascertainment of a quantity of three-dimensional data points of the first data within the initiated and/or ascertained three-dimensional bounding volume of the object. Similarly to the first target function and second target function, the third target function also comprises the 3D point population term. In this regard, however, in the case of the third target function, the bounding volume is not defined as a cylinder or sphere, in contrast to the first target function. There is also the possibility of not allowing the extension of three-dimensional bounding volume along the y axis (vertical axis) to be incorporated into the ascertainment of the quantity of three-dimensional data points, since the robustness of the second term toward errors relating to the ascertainment of the ground plane may be increased thereby.

Similarly to the first target function, the third target function may likewise comprise a bounding volume distance term, which favors orientations of the three-dimensional bounding volume during the optimization, in which the distance of the three-dimensional bounding volume to the surface of the object facing the sensor is as short as possible.

The third target function can comprise the first and second terms. According to one preferred refinement of the invention, it is also preferably provided that the first term has a higher weighting and preferably twice as high a weighing±20% than the second term. It has been shown that a weighting of this type leads to particularly good results in the ascertainment of the three-dimensional bounding volume.

In connection with solving the mathematical optimization procedure, it is provided according to an example that an algorithm can be used to carry out the mathematical optimization procedure, which does not use a gradient or finite differences to determine the search direction. An algorithm from the group of so-called random search algorithms is thus particularly preferably used. Since they are not dependent on the gradient or on finite differences for finding a minimum or maximum, these algorithms are particularly suitable for optimizing non-consistent and/or non-derivable target functions.

It is possible, that the method can be applied using static first and second data—i.e., not comprising a time dimension. In any case, therefore, the information data of a two-dimensional minimum bounding polygon, preferably a two-dimensional minimum bounding rectangle, for the object displayed on a camera image is received along with the first data of the recorded lidar or radar sensor temporally correlated thereto. However, the first and second data preferably have a time dimension, i.e., multiple temporally consecutive items of lidar or radar sensor data in relation to the first data and multiple temporally consecutive image data in relation to the second data. It is preferably provided that an object tracking is carried out in the case of second data having a time dimension, and pieces of information obtained by the object tracking are taken into account in the mathematical optimization procedure. The temporally consecutive image data are preferably compared with each other to identify objects moving in this manner and/or static objects and to determine whether the displayed object is an object which is also displayed in temporally earlier and/or in temporally later image data. In the case of moving objects, a trajectory of the object is preferably captured. According to an example of the invention, it is therefore provided that the first data and the second data each have a time dimension and it is taken into account during the optimization that the shape of the ascertained three-dimensional bounding volume does not change by more than one predefined limit value for the object over time.

A bounding volume which does not change its shape over time, in particular, a bounding volume which does not change its size, is therefore preferably favored during the optimization. In visual terms, the fact is thus utilized during the optimization that the size, for example of a vehicle which is displayed in temporally consecutive image data, is not able to suddenly change.

the first data and the second data can each have a time dimension and, it is taken into account during the optimization that: jump discontinuities in a trajectory of the ascertained three-dimensional bounding volume do not exceed a predefined size; and/or the ascertained three-dimensional bounding volume does not exceed and/or drop below a predefined instantaneous speed; and/or the ascertained three-dimensional bounding volume does not exceed and/or drop below a predefined instantaneous acceleration.

In other words, the consistency of the trajectory, in relation to the position, the speed, and the acceleration of the bounding volume, is also used to give preference to the most consistent results possible during the optimization. In visual terms, the fact is therefore utilized during the optimization that, for example, a vehicle displayed in consecutive image data is moved through the space in a continuous manner.

The object of the invention is also achieved by a device for processing data, which comprises, for example, a processor and memory for carrying out the method described above.

The invention additionally relates to a computer program product, comprising commands, which, when the program is executed by a computer, prompt the latter to carry out the method described above.

According to the invention, a computer-readable data carrier is furthermore provided, on which the above computer program product is stored.

The technical advantages of the device for processing data, the computer program product, and the computer-readable data carrier are derived for those skilled in the art from the description of the method for ascertaining a three-dimensional bounding volume as well as from the example described below.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a flowchart of a computer-implemented method for ascertaining a three-dimensional bounding volume according to an example of the invention;

FIG. 2 schematically shows a representation of a 2D/3D consistency term of a target function, which is used in a position optimization of the method for ascertaining the three-dimensional bounding volume from FIG. 1;

FIG. 3 schematically shows a representation of a procedure for ascertaining a 3D point population term of a target function, which is used in a position optimization of the method for ascertaining the three-dimensional bounding volume from FIG. 1;

FIG. 4 schematically shows a representation of a sum of the function illustrated in FIG. 2 and the 3D point population term from FIG. 3;

FIGS. 5A and 5B schematically shows a representation of the procedure for ascertaining a bounding volume distance term of a target function, which is used in a position optimization of the method for ascertaining the three-dimensional bounding volume from FIG. 1; and

FIG. 6 schematically shows a representation of a 2D/3D consistency term of a target function, which is used in an orientation optimization of the method for ascertaining the three-dimensional bounding volume from FIG. 1.

### DETAILED DESCRIPTION

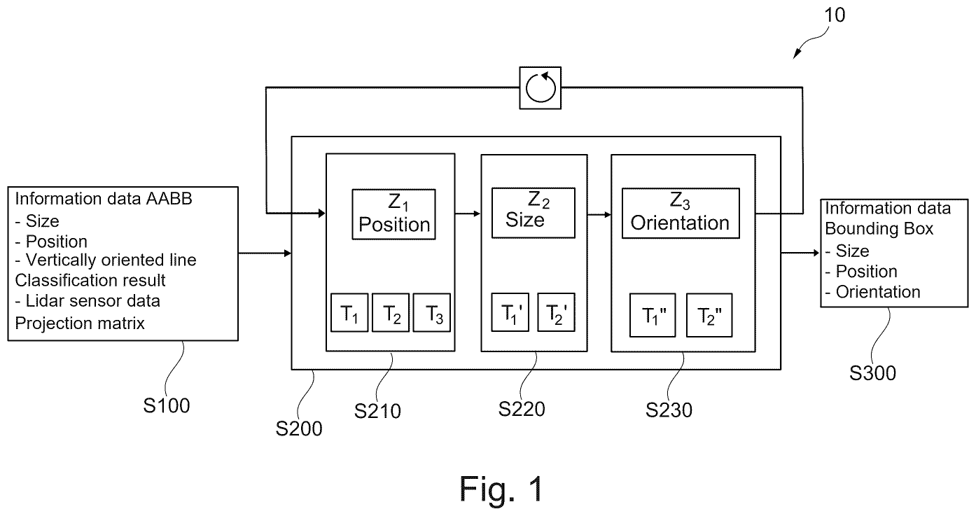

FIG. 1 schematically shows an example of a flowchart 10 of a computer-implemented method for ascertaining a three-dimensional bounding volume according to an example of the invention.

As is apparent in FIG. 1, in this example of the method, information data of a two-dimensional minimum axis-aligned bounding box (AABB) of an object displayed on image data are received in a first step S100. The image data have two spatial dimensions and were recorded with the aid of a camera.

In the present case, the received information data define the size and position of the AABB in the image data. The information data also comprise a vertically oriented line, which identifies the vertically running edge of the object displayed on the image data which is closest to the recording camera. A classification result of the object displayed on the image data is furthermore received. In the present example, the object displayed on the image data was assigned to the passenger car class.

In the example, lidar sensor data 12 are also received in first step S100, which are temporally correlated to the image data recorded by the camera. Lidar sensor data 12 have three spatial dimensions. A projection matrix is furthermore received, which defines a mapping of a three-dimensional data point 14 of lidar sensor data 12 to a two-dimensional data point in the image data. Examples of lidar sensor data 12 are illustrated in FIGS. 3 and 5A and 5B.

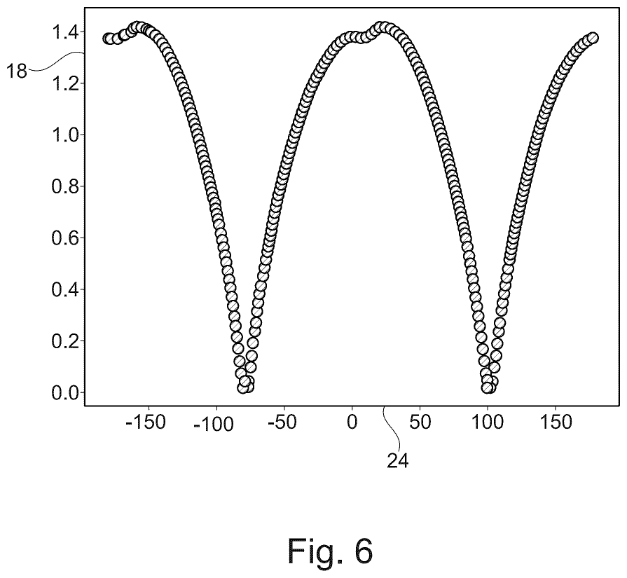

In step S200, the three-dimensional bounding volume is subsequently ascertained with the aid of a mathematical optimization procedure, in the present case in the form of a bounding box 16 (also illustrated in FIG. 6) of the object. Information data of bounding box 16 are thus present in step S300 as the result of the optimization procedure, these information data defining a size, a position, and an orientation of bounding box 16 in lidar sensor data 12.

In the example, the mathematical optimization procedure in step S200 comprises an optimization of three target functions Z₁, Z₂, Z₃, each including fewer than 100 terms, only the position of bounding box 16 being optimized with the aid of first target function Z₁ in step S210, only the size of bounding box 16 being optimized with the aid of second target function Z₂ in step S220, and only the orientation of bounding box 16 being optimized with the aid of third target function Z₃ in step S230. The three target functions Z₁, Z₂, Z₃ are minimized iteratively, it being apparent on the basis of FIG. 1 that first target function Z₁ is minimized first, followed by second target function Z₂, and then by third target function Z₃.

During the optimization the information data of bounding box 16 are initiated in each case; by projecting initiated bounding box 16, information data of back-projected AABB′ are generated with the aid of the projection matrix, and the generated information data of AABB′ are compared with the information data of original AABB received in step S100, this process being repeated until an abort criterion is reached. In addition, received lidar sensor data 12 are taken into account in the optimization, in that bounding boxes 16 are given preference which best match lidar sensor data 12.

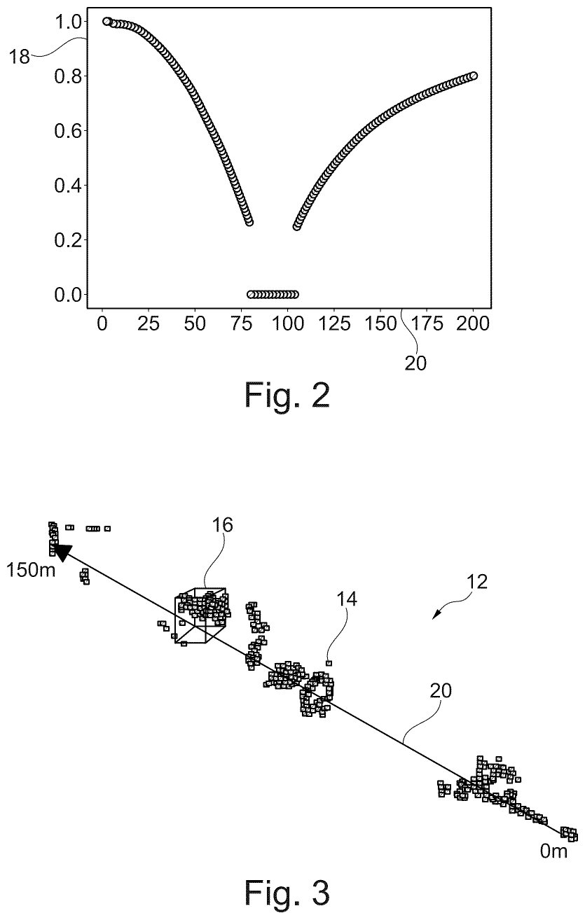

The three target functions Z₁, Z₂, Z₃ and the optimization process are explained in greater detail below with reference to the further FIGS. 2 through 6:

First target function Z₁ for optimizing the position of bounding box 16 is, in the present case, a linear combination of three terms T₁, T₂, T₃. In the present case, first term T₁ is a 2D/3D consistency term T₁, the ascertainment of the 2D/3D consistency term comprising the comparison of the generated information data with the received information data. FIG. 2 schematically shows a representation of 2D/3D consistency term T₁, which may assume values between 0 and 1—as is apparent on y axis 18 in FIG. 2.

In the present case, 2D/3D consistency term T₁ is essentially defined by the following formula, where IoU stands for Intersection over Union, in which original AABB and back-projected AABB′ form a corresponding middle:

$${T}_{1} \approx 1 - IoU ( AABB , {AABB}^{′} )$$

It is also apparent from FIG. 2 that 2D/3D consistency term T₁ comprises a tolerance term, so that 2D/3D consistency term T₁ has its minimum value of 0 even in the case of non-ideally matching AABBs. X axis 20 in FIG. 2 corresponds to the position of bounding box 16 on z axis 20 of a clockwise spatial coordinate system, in which z axis 20 is defined by the depth detection of the lidar sensor, and the y axis is defined by the vertical direction. In visual terms, FIG. 2 thus shows that, assuming a position of 0 meters directly at the lidar sensor, bounding box 16 is poorly positioned, since back-projected AABB′ corresponds poorly to original AABB, while at a position approximately 75 m to 100 m away from the lidar sensor on z axis 20, a good correspondence exists between back-projected AABB′ and original AABB. It is also apparent from FIG. 2 that 2D/3D consistency term T₁ comprises a distance term, great distances to the lidar sensor being easily favored, and the symmetry of the Intersection over Union being eliminated.

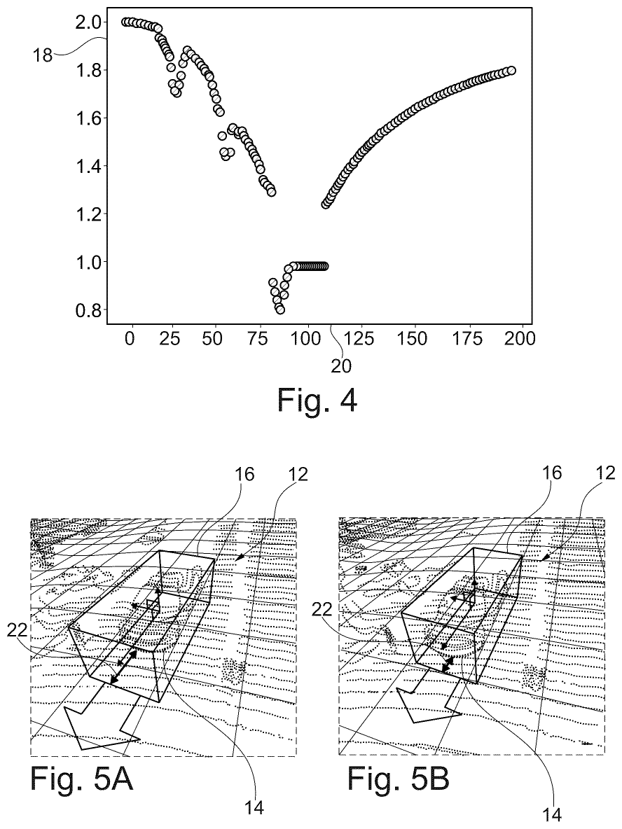

Second term T₂ of first target function Z₁ is a 3D point population term T₂ in this example. FIG. 3 schematically shows the procedure for ascertaining 3D point population term T₂, while FIG. 4 shows the weighted sum of 2D/3D consistency term T₁ from FIGS. 2 and 3D point population term T₂.

3D point population term T₂ is ascertained in the present case in that a quantity of three-dimensional data points 14 of lidar sensor data 12 is determined within a volume co-determined by bounding box 16. In the present case, the volume corresponds to that of a cylinder, whose rotation axis is in parallel to the y axis of the spatial coordinate system and runs through the center of bounding box 16. This subgroup of points is referred to as Pin. Pin is also normalized, in that it is divided by Pₙₒᵣₘ, Pₙₒᵣₘ corresponding to the quantity of three-dimensional data points 14 of lidar sensor data 12 situated within a frustum, which has the same opening angle as the AABB defined by the received information data. In the present case, T₂ is thus determined as:

$${T}_{2} = 1 - {P}_{i n} / {P}_{norm}$$

In visual terms, bounding box 16 is therefore shifted along z axis 14 of the spatial coordinate system in FIG. 3 and, in each case, ascertains how many three-dimensional data points 14 are situated within a cylinder running through bounding box 16. FIG. 3 also shows all other three-dimensional data points 14 situated within the frustum, the quantity of which is used for normalization. It is apparent from FIG. 4, which illustrates the weighted sum of T₁ and T₂, T₁ being weighted with a factor of 2 and T₂ with a factor of 1, that a particularly large quantity of data points 14 are situated within the cylinder at approximately 25 m, at approximately 50 m, and at approximately 80 m. The weighted sum of T₁ and T₂ has a minimum at approximately 80 m.

Third term T₃ of first target function Z₁ in this example is a bounding volume distance term T₃, which is ascertained by ascertaining a distance of a surface of bounding box 16 to a side of the object facing the lidar sensor. FIG. 5 schematically illustrates the procedure for ascertaining bounding volume distance term T₃. It is clearly apparent in FIGS. 5A and 5B that the object—the passenger car in the present case—is scanned only on surfaces pointing in the direction of the lidar sensor, so that no data points 14 are present for the back side of the passenger car facing away from the lidar sensor. Accordingly, pieces of local information of lidar sensor data 12—the local point density of three-dimensional data points 14 in this case—may be used to identify surfaces of the object in lidar sensor data 12 facing the lidar sensor. Based on the identified surface of the object, the bounding volume distance term is ascertained, which favors positions of bounding box 16 during the optimization at which distance 22 of bounding box 16 to the surface of the object facing the sensor is as short as possible.

FIG. 5A shows a position of bounding box 16 in lidar sensor data 12, at which distance 22 is long and the bounding volume distance term correspondingly has a high value, while FIG. 5B shows a position of bounding box 16 in lidar sensor data 12, at which distance 22 is short and the bounding volume distance term correspondingly has a low value. The position of bounding box 16 as shown in FIG. 5B is correspondingly preferred during the optimization of the position with the aid of first target function T₁. Third term T₃ is weighted the lowest in first target function Z₁.

In the example, first target function Z₁ is thus the following linear combination of terms T₁, T₂, T₃:

$${Z}_{1} = 2 {T}_{1} + 1 {T}_{2} + 0.01 {T}_{3}$$

In step S210, the position is optimized by an estimate for the orientation and size of bounding box 16. In this example, it is provided in relation to estimating the orientation of bounding box 16 that the received vertical line is used for this purpose. The received classification result is used in relation to estimating the size of bounding box 16.

After the optimization is concluded in step S210 with the aid of first target function Z₁, the size of bounding box 16 is optimized in step 220 with the aid of second target function Z₂ and the optimized values obtained in step S210 for the position of bounding box 16. In the example, a second target function Z₂ is used for this purpose, which comprises the two terms T₁′ and T₂′.

Similarly to term T₁ of first target function Z₁, first term T₁′ is a 2D/3D consistency term, the ascertainment of the 2D/3D consistency term comprising the comparison of the generated information data with the received information data.

Second term T₂′ is a prior knowledge term T₂′ and takes into account the classification result of the object. In the present case, prior knowledge term T₂′ is defined as follows:

$${T}_{2}^{′} = 1 - P ( M \vert K )$$

where M is a Gaussian mixture model of the size distributions of possible classes K, and P (M|K) stands for the conditional probability and describes the probability for the size of the object under the condition of the classification result of the object. In this way, during the optimization, sizes of bounding box 16 are favored by prior knowledge term T₂′ which are close to the mean and/or median value(s) of the corresponding sub-populations of class K.

In the example, second target function Z₂ is thus the following linear combination of terms T₁′ and T₂′:

$${Z}_{2} = {T}_{1}^{′} + {T}_{2}^{′}$$

After the optimization is concluded in step S220 with the aid of second target function Z₂, the orientation of bounding box 16 is optimized in step S230 with the aid of third target function Z₃ and the optimized values obtained in steps S210 and S220 for the position and size of bounding box 16. In the example, a third target function Z₃ is used for this purpose, which comprises the two terms T₁″ and T₂″.

Similarly to term T₁ of first target function Z₁, first term T₁″ is a 2D/3D consistency term, the ascertainment of 2D/3D consistency term T₁″ comprising the comparison of the generated information data generated by back-projecting the AABB with the received information data of the AABB.

FIG. 6 schematically shows a representation of 2D/3D consistency term T₁, which may assume values between 0 and 1.4—as is apparent on y axis 18 of FIG. 6. In the present case, 2D-3D consistency term T₁″ is defined by the following formula, where SV stands for the aspect ratio of original AABB, and SV′ stands for the aspect ratio of back-projected AABB′.

$${T}_{1}^{′′} = \vert SV - {SV}^{′} \vert + \vert \frac{\frac{1}{SV} - \frac{1}{{SV}^{′}}}{2} \vert$$

In particular, the yaw angle, a rotation around the y axis (vertical axis) of the spatial coordinate system, influences the aspect ratio of back-projected AABB′. In FIG. 6, x axis 24 corresponds to the yaw angle of bounding box 16, 0 degrees corresponding to an orientation at which z axis 20 of the spatial coordinate system, which is defined by the depth detection of the lidar sensor, corresponds to the normal vector of one side of bounding box 16. In visual terms, FIG. 6 thus shows that bounding box 16 is well oriented at an assumed yaw angle of 100 degrees or −80 degrees, since back-projected AABB′ corresponds well to original AABB.

Second term T₂″ of third target function Z₃ is a 3D point population term, similarly to term T₂ of first target function Z₁. However, the volume of bounding box 16 is used and not the volume of a cylinder.

In the example, third target function Z₃ is thus the following linear combination of terms T₁″ and T₂″:

$${Z}_{3} = 2 {T}_{1}^{′′} + 1 {T}_{2}^{′′}$$

In the example, after the optimization is concluded in step S230 with the aid of third target function Z₃, the position of bounding box 16 is again optimized with the aid of first target function Z₁ and the optimized values obtained in steps S220 and S230 for the size and orientation of bounding box 16. The already optimized position is preferably used as the starting value for the position. The subsequent optimizations then take place in an iterative process, as described above, until the abort criterion is reached.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for ascertaining a three-dimensional bounding volume for an object displayed on first data, the first data comprising at least three spatial dimensions, the method comprising:
receiving information data of a two-dimensional minimum bounding polygon or a two-dimensional minimum bounding rectangle for the object displayed on second data, the second data comprising at least two spatial dimensions, the received information data defining a size and a position of the minimum bounding polygon of the object in the second data;
receiving a projection matrix, the projection matrix defining a mapping of a three-dimensional data point of the first data onto a two-dimensional data point in the second data;
ascertaining the three-dimensional bounding volume of the object with the aid of a mathematical optimization procedure and a target function, the target function comprising fewer than 100,000 terms or fewer than 10,000 terms or fewer than 1,000 terms;
initiating information data of the three-dimensional bounding volume of the object, the information data defining a size, a position, and an orientation of the bounding volume of the object in the first data;
generating information data of a further two-dimensional minimum bounding polygon by projecting the initiated bounding volume with the aid of the received projection matrix; and
comparing the generated information data with the received information data.

2. The method according to claim 1, wherein the first data are a point cloud recorded with the aid of a lidar or radar sensor, and/or wherein the second data is image data recorded with the aid of a camera.

3. The method according to claim 1, wherein the method further comprises: receiving the first data, the received data being taken into account when ascertaining the three-dimensional bounding volume of the object with the aid of a mathematical optimization procedure.

4. The method according to claim 1, wherein the mathematical optimization procedure comprises an optimization of three target functions, each including fewer than 100,000 terms, wherein only a position of the three-dimensional bounding volume is optimized with the aid of the first target function, only a size of the three-dimensional bounding volume is optimized with the aid of the second target function, and only an orientation of the three-dimensional bounding volume is optimized with the aid of the third target function, and/or wherein the mathematical optimization procedure comprises an iterative optimization of the three target functions and is begun with the first target function.

5. The method according to claim 4, wherein the first target function comprises at least one term or is a linear combination of at least three terms, the first term being a 2D/3D consistency term, which is ascertained by comparing the generated information data with the received information data, and/or wherein the method further comprises:
receiving the first data, and the second term is a 3D point population term, which is ascertained by an ascertainment of a quantity of three-dimensional data points of the first data within the initiated and/or ascertained three-dimensional bounding volume of the object; and/or wherein the third term is a bounding volume distance term, which is ascertained by ascertaining a distance of a surface of the bounding volume to a side of the object or a side thereof facing the lidar or radar sensor.

6. The method according to claim 5, wherein the first term has a higher weighting or a double weighting±20% than the second term, and wherein the second term has a higher weighting or a weighting that is at least 50 times as high as the third term.

7. The method according to claim 4, wherein the second target function comprises at least one term or is a linear combination of at least two terms, the first term being a 2D/3D consistency term, which is ascertained by comparing the generated information data with the received information data; and/or wherein the second term is a prior knowledge term, and wherein the method further comprises: receiving a classification result of the object.

8. The method according to claim 7, wherein the first term and the second term have the same weighting or ±20% of the same weighting.

9. The method according to claim 4, wherein the third target function comprises at least one term or a linear combination of at least two terms, wherein the first term is a 2D/3D consistency term, which is ascertained by comparing the generated information data with the received information data, and/or wherein the method comprises: receiving the first data, and the second term is a 3D point population term, which is ascertained by an ascertainment of a quantity of three-dimensional data points of the first data within the initiated and/or ascertained three-dimensional bounding volume of the object.

10. The method according to claim 9, wherein the first term has a higher weighting or a weighting which is twice as high or a weighting that is ±20% than the second term.

11. The method according to claim 1, wherein an algorithm is used to carry out the mathematical optimization procedure, which does not use a gradient or finite differences to determine the search direction.

12. The method according to claim 1, wherein the first data and the second data each have a time dimension, wherein the time dimension is taken into account during the optimization such that the shape of the ascertained three-dimensional bounding volume does not change more than one predefined limit value for the object over time or wherein the time dimension is taken into account during the optimization such that jump discontinuities of a trajectory of the ascertained three-dimensional bounding volume do not exceed a predefined size, and/or wherein the ascertained three-dimensional bounding volume does not exceed and/or drop below a predefined instantaneous speed, and/or wherein the ascertained three-dimensional bounding volume does not exceed and/or drop below a predefined instantaneous acceleration.

13. A computing environment for processing data, comprising a processor and memory to carry out the method according to claim 1.

14. A computer program product, comprising commands, which, when the program is executed by a computer, prompt the computer to carry out the method according to claim 1.

15. A computer-readable data carrier, on which the computer program product according to claim 14 is stored.

16. The computer implemented method according to claim 1, wherein the three-dimensional bounding volume is a bounding box.
